(19) United States
(12) Patent Application Publication
(10) Pub. No.: US 2025/0279914 A1
(43) Pub. Date: Sep. 4, 2025

(54) DEFERRED PRECISION FOR EQUALIZATION, DETECTION, AND SIGNAL RECONSTRUCTION

(71) Applicant: MaxLinear, Inc., Carlsbad, CA (US)

(72) Inventors: Curtis Ling, Carlsbad, CA (US); Sridhar Ramesh, Carlsbad, CA (US)

(73) Assignee: MaxLinear, Inc., Carlsbad, CA (US)

(21) Appl. No.: 19/067,740

(22) Filed: Feb. 28, 2025

Related U.S. Application Data
(60) Provisional application No. 63/560,469, filed on Mar. 1, 2024.

(51) Int. Cl. H04L 25/03

(52) U.S. Cl. CPC H04L 25/03019; H04L 2025/03598

(57) ABSTRACT

A method may include receiving, at a receiver, a signal comprising a symbol. The method may include performing, at the receiver, a first operation using a number of most significant bits by gating a selected number of least significant bits. The method may include detecting, at the receiver, a symbol value of the symbol using the first operation.

### RELATED APPLICATION

This application claims the benefit of U.S. Provisional Application No. 63/560,469, filed Mar. 1, 2024, the disclosure of which is incorporated herein by reference in its entirety.

The examples discussed in the present disclosure are related to digital receivers and associated methods for equalization.

### BACKGROUND

Unless otherwise indicated herein, the materials described herein are not prior art to the claims in the present application and are not admitted to be prior art by inclusion in this section.

Digital communication systems map discrete symbols which may be modulated and transmitted as signals. The communication channel may impart noise, non-linear characteristics, and dispersion on the signal as the signal travels through the communication medium. The receiver may attempt to recover the signal embedded within the noise and other impairments. Methods for recovering the signal while balancing power constraints and performance constraints may be useful.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

A method may include receiving, at a receiver, a signal comprising a symbol. The method may include performing, at the receiver, a first operation (e.g., a first equalization operation) using a number of most significant bits by gating a selected number of least significant bits. The method may include detecting, at the receiver, a symbol value of the symbol using the first operation (e.g., a first equalization operation).

A system for reduced precision may include a most-significant multiplier, a least significant multiplier, and an adder. The most-significant multiplier may receive one or more first most-significant inputs and one or more second most-significant inputs and generate a most-significant output. The least significant multiplier may receive one or more least-significant inputs or one or more zero inputs and generate a least-significant output. The adder may receive the most-significant output and the least-significant output and generate a deferred precision output.

A system for reduced precision may include an equalizer, a circular buffer, and a gate. The equalizer may include multiple taps. The circular buffer may output one or more full precision outputs. The gate may output the one or more full precision outputs to the equalizer when a full precision region is identified.

A system for deferred precision may include using the information obtained from symbols falling within a hard decision region after the first processing operation (e.g., a first equalization operation) to assist in resolving symbols not landing within that region following the first processing operation. Non-limiting examples of such assisted deferred precision may include: (i) decision feedback equalization, (ii) maximum likelihood sequence estimation, or the like.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates example graphs for digital communication systems.

FIG. 2 illustrates example graphs for receiver signal processing.

FIG. 3A illustrates an example graph for deferred precision.

FIG. 3B illustrates an example graph for deferred precision.

FIG. 4A illustrates an example graph for deferred precision.

FIG. 4B illustrates an example graph for deferred precision.

FIG. 5 illustrates an example diagrammatic representation for deferred precision.

FIG. 6 illustrates an example block diagram for deferred precision.

FIG. 7 illustrates a block diagram of an example system configured to perform deferred precision.

FIG. 8 illustrates an example process flow for deferred precision.

FIG. 9 illustrates a diagrammatic representation of a machine in the example form of a computing device within which a set of instructions, for causing the machine to perform any one or more of the methods discussed herein, may be executed.

FIG. 10 illustrates an example graph for deferred precision.

FIG. 11 illustrates an example diagrammatic representation for deferred precision.

### DESCRIPTION

Receiver signal processing may involve equalization which may compensate for channel dispersion and other impairments. A digital transmitter may map a signal to transmitting symbols and transmit the signal over a communication medium. Reconstructing the signal may be performed by mapping the signal to the transmitted symbols.

Receiver signal processing may be power intensive. Therefore, methods of reducing power usage in receiver signal processing without sacrificing performance may be useful.

Deferred precision may be used to reduce power usage without sacrificing performance. Avoiding full precision calculations may have a strong effect on power consumption. Deferred precision may be combined with partial equalization or applied independently to reduce power consumption. Deferred precision may overlay onto a system which uses partial equalization. Deferred precision may be used for systems where hard decisions are made using a measure of certainty and/or probability such as machine learning or artificial intelligence classification and training. Deferred precision may also be used for belief propagation and/or low density parity checks (LDPC).

In addition, information that is received by processing symbols that fall within a hard decision region may be used to resolve symbols that do not fall within the hard decision region (i.e., that fall within the deferred decision region). Some use cases may include e.g., decision feedback equalization, maximum likelihood sequence estimation, belief propagation, and/or low density parity check (LDPC) coding. In these cases, partial information (e.g., information obtained using deferred precision) may be used to determine information that does not fall within a hard decision region. Alternatively or in addition, information that falls within a hard decision region may be used without determining information that does not fall within a hard decision region. Omitting operations that do not fall within a hard decision region may reduce processing power relative to a baseline.

Deferred precision may be applied to numerous techniques beyond equalization, detection, and signal reconstruction. For example, deferred precision may be used in classification, decoding, and quantization. In the case of classification of images and/or videos, a first pass on a low resolution image may be facilitated (e.g., the base layers with layered encoding). A conditional second pass may be facilitated if the first pass classification is not successful. In the case of decoding, iterative decoding with early termination may be provided. For example decoding may use a low density parity check decoder or a Viterbi decoder. In the case of quantization of signals/voltages, a first pass of the signals/voltages may be facilitated and then a conditional second pass may be provided if the first-pass is not successful.

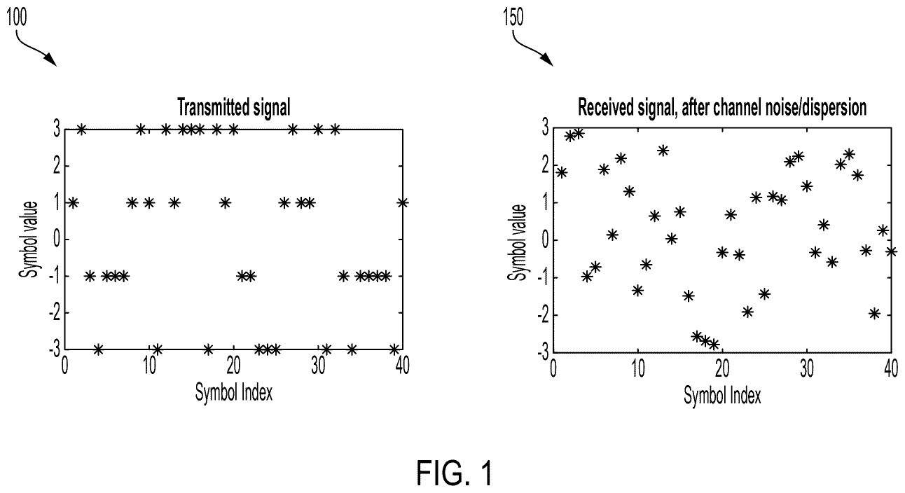

FIG. 1 illustrates example graphs for digital communication systems. Information may be mapped to discrete “symbols”, then modulated and transmitted as a signal. A graph 100 of the transmitted signal has a symbol index (e.g., ranging from 0 to 40) that is mapped to a symbol value (e.g., having a symbol value of −3, or −1, or 1, or 3). The communication channel may impart noise, non-linearity, and/or dispersion on the signal. A graph 150 of the received signal after channel noise and/or dispersion shows a symbol index (e.g., ranging from 0 to 40) and a symbol value (e.g., having a symbol value ranging between −3 and 3). The four discrete symbol values of the graph 100 have been replaced by additional values in the graph 150. The receiver may attempt to recover the signal embedded within noise and other impairments, e.g., using Pulse Amplitude Modulation in intensity modulation direct detection (IMDD)-optical communication systems.

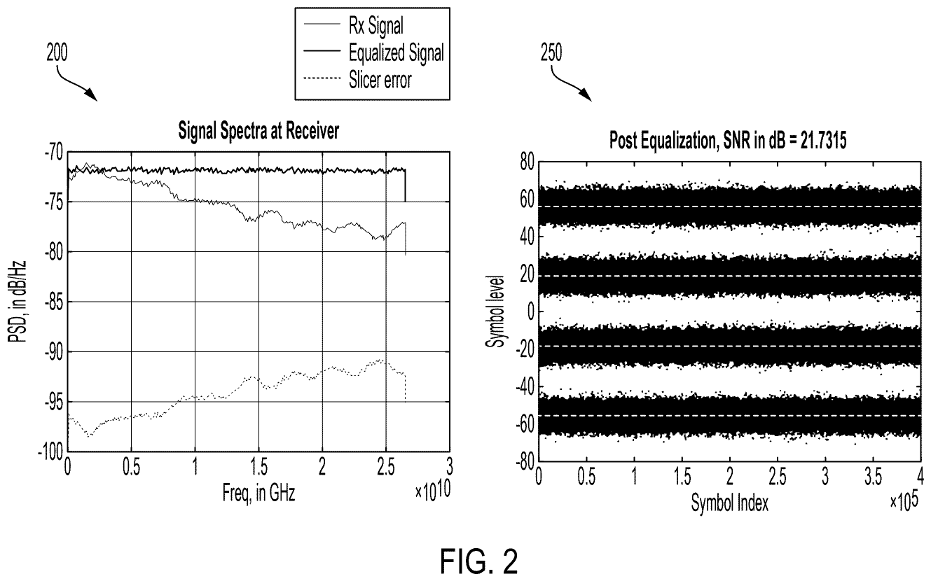

FIG. 2 illustrates example graphs 200, 250 for receiver signal processing. Equalization may compensate for channel dispersion. In graph 200, the power spectral density (PSD) in decibels per hertz (dB/Hz) is plotted against the frequency in gigahertz (GHz) to show the signal spectra at the receiver of various signals and errors. In graph 200, a received (Rx) signal is shown, an equalized signal is shown, and a slicer error is shown. In graph 250, the symbol level is plotted as a function of the symbol index in a post equalization graph in which the signal-to-noise ratio (SNR) in dB is 21.7315. Detection may be used to map the signal to the transmitted symbols. This may be accomplished using a simple slicer (e.g., using the minimum distance to nominal symbol level) or Maximum Likelihood Sequence Detection on un-equalized or partially equalized signals.

Deferred precision may be used in receiver signal processing. Methods for deferred precision may include receiving, at a receiver, a signal including a symbol. The method may include performing, at the receiver, a first operation (e.g., a first equalization operation) using a number of most significant bits by gating a selected number of least significant bits. The method may include detecting, at the receiver, a symbol value of the symbol using the first operation (e.g., the first equalization operation).

When deferred precision is used, computations using full precision may be used when a full precision computation is indicated by a threshold. The full precision region may be set based on a target symbol error rate. Deferred precision may be used alternatively or in addition to deferred decision. The multipliers in an equalization operation (e.g., feed forward equalization (FFE)) may facilitate selectable deferred precision. That is, the multipliers may output the most significant bits before outputting the least significant bits. This may be implemented by gating the least significant bits.

When deferred precision is used, the FFE response may be altered which may generate quantization noise. The number of bits used in deferred precision may be selected so that the quantization noise is less than the width of a deferred decision region. When a value falls within the deferred decision region, the least significant bits may be ungated to generate the full precision results.

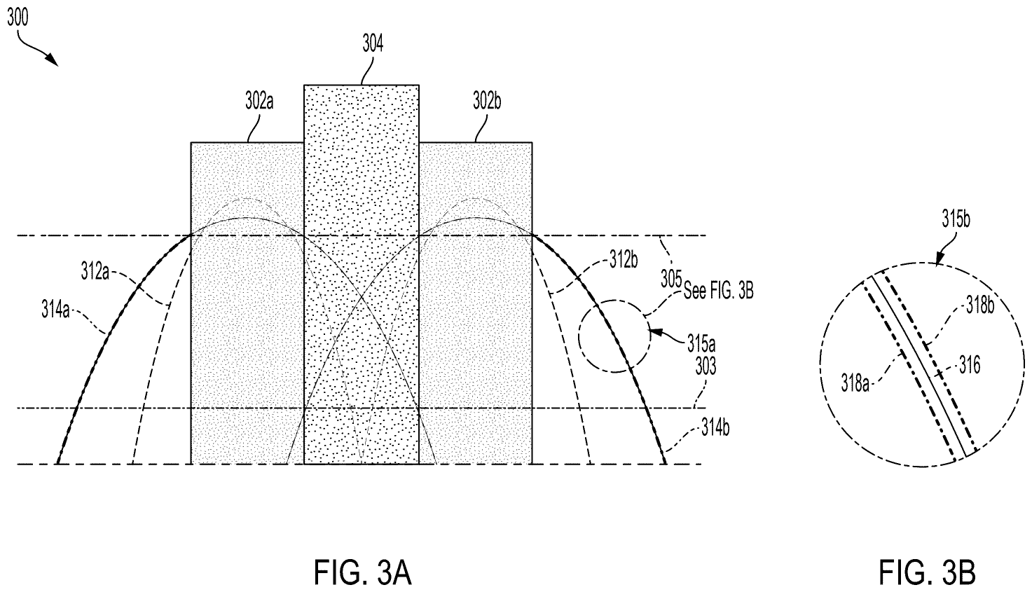

As illustrated in the graph 300 in FIG. 3A, a hard decision threshold 305 may set a hard decision region (HDR) 302a, 302b and a deferred decision region (DDR) 304. The hard decision threshold 305 may be based on a target symbol error rate (SER) 303. The SER floor 301 may be an achievable SER.

When deferred precision is used, the curves 312a, 312b may be widened to reduce the percentage of the curve 314a, 314b in the hard decision region 302a, 302b. As illustrated in FIG. 3B, a close-up region 315b of the region 315a shows that the line 316 may include quantization error 318a, 318b. In the close-up region 315b, the area surrounding the line 316 is the quantization error 318a, 318b.

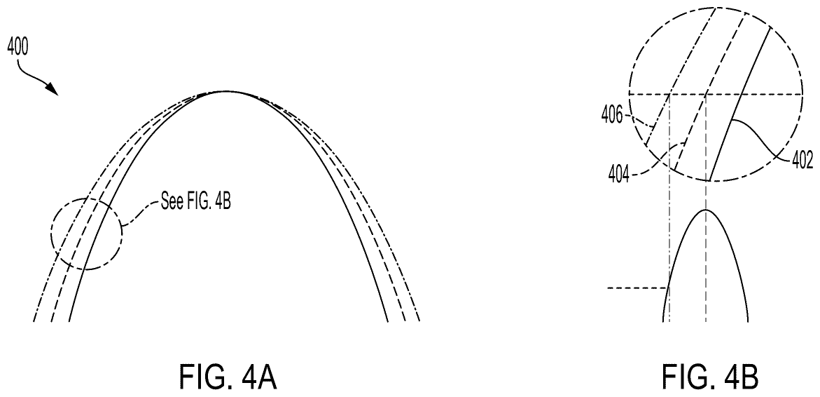

As illustrated in FIG. 4A in the diagram 400, when deferred precision is used, an allowance may be provided for rounding and quantization noise (ng). As illustrated in FIG. 4B, the histogram of full precision equalization (e.g., feed forward equalization (FFE)) may be shown by the line 402. The line 404 may show a histogram of reduced precision equalization (e.g., FFE). The line 406 may show a histogram of reduced precision equalization plus an allowance for quantization noise. The complementary error function (ERFC) of the quantization noise at the equalization output (e.g., FFE output) may be sufficiently low because the quantization noise may have a Gaussian distribution.

Quantization noise may be considered when using deferred precision. A method may include computing, at the receiver, quantization noise in response to the first equalization operation. Alternatively or in addition, the method may include adjusting, at the receiver, the number of most significant bits based on the quantization noise. Alternatively or in addition, the quantization noise may be less than a width of a deferred precision region.

The deferred precision region and the full precision region may be computed. The method may include computing, at the receiver, a deferred precision region based on the selected number of the least significant bits. The method may include computing, at the receiver, a full precision region based on the selected number of the least significant bits. The method may include using, at the receiver, the selected number of the least significant bits when the symbol value is in the full precision region. The method may include selecting, at the receiver, a deferred precision threshold. The method may include computing, at the receiver, a deferred precision region based on the deferred precision threshold. The method may include performing, at the receiver, the first equalization operation using a feed forward equalizer.

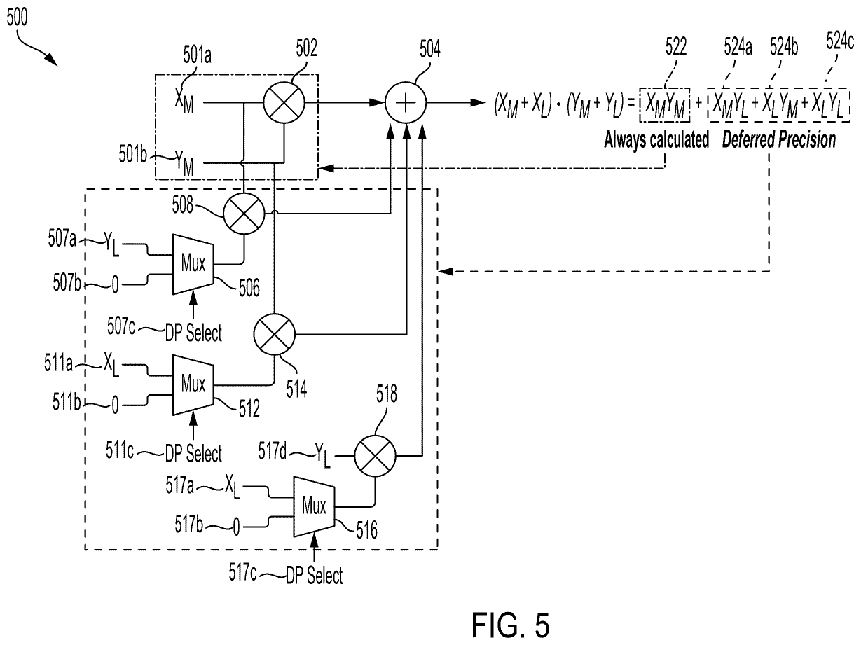

As illustrated in FIG. 5, a system 500 for reduced precision may include one or more most-significant multipliers 502 that may receive one or more first most-significant inputs 501a (e.g., first most significant bit inputs such as X_{M}) and one or more second most-significant inputs 501b (e.g., second most significant bit inputs such as Y_{M}) and generate one or more most-significant outputs 522 (e.g., first most significant bit outputs such as X_{M}Y_{M}).

The system 500 may include one or more least-significant multipliers 508, 514, 518 that may receive one or more inputs 507a, 511a, 517a (e.g., least-significant inputs such as X_{L} or Y_{L}) and/or one or more zero inputs 507b, 511b, 517b (e.g., a value of zero as indicated by ‘0’) and generate one or more least-significant outputs such as 524a, 524b, 524c (e.g., least significant bit outputs).

For example, a least-significant multiplier 508 may receive a least-significant input 507a and/or a zero input 507b and generate a least-significant output 524a. The least-significant input 507a and/or the zero input 507b may be selected (e.g., Deferred Precision (DP) Select 507c) using a multiplexer 506. The least-significant output 524a may be generated using the first most-significant input 501a (e.g., first most significant bit input such as X_{M}). That is, a least-significant multiplier 508 may receive a least-significant input 507a and/or a first most-significant input 501a to generate the least-significant output 524a. Alternatively or in addition, the least-significant multiplier 508 may receive a zero input 507b and/or a first most-significant input 501a to generate the least-significant output 524a. When the zero input 507b is used, then the value of the least-significant output 524a may be zero.

For example, a least-significant multiplier 514 may receive a least-significant input 511a and/or a zero input 511b and generate a least-significant output 524b. The least-significant input 511a and/or the zero input 511b may be selected (e.g., DP Select 511c) using a multiplexer 512. The least-significant output 524b may be generated using the second most-significant input 501b (e.g., second most significant bit inputs such as Y_{M}). That is, a least-significant multiplier 514 may receive a least-significant input 511a and/or a second most-significant input 501b to generate the least-significant output 524b. Alternatively or in addition, the least-significant multiplier 514 may receive a zero input 511b and/or a second most-significant input 501b to generate the least-significant output 524b. When the zero input 511b is used, then the value of the least-significant output 524b may be zero.

For example, a least-significant multiplier 518 may receive a least-significant input 517a and/or a zero input 517b and generate a least-significant output 524c. The least-significant input 517a and/or the zero input 517b may be selected (e.g., DP Select 517c) using a multiplexer 516. The least-significant output 524c may be generated using an additional least-significant input 517d (e.g., Y_{L}). That is, a least-significant multiplier 518 may receive a least-significant input 517a and/or an additional least-significant input 517d to generate the least-significant output 524c. Alternatively or in addition, the least-significant multiplier 518 may receive a zero input 517b and/or an additional least-significant input 517d to generate the least-significant output 524c. When the zero input 517b is used, then the value of the least-significant output 524c may be zero.

The most-significant output 522 may be calculated when least-significant outputs (e.g., least-significant output 524a, least-significant output 524b, and least-significant output 524c) are not calculated. Alternatively or in addition, least-significant output 524a, least-significant output 524b, and least-significant output 524c may be calculated when full precision is used.

The system 500 may include an adder 504 that may receive the most-significant output 522 (e.g., first most significant bit outputs) and the one or more least-significant outputs (e.g., least significant bit outputs) and generate a deferred precision output. The one or more least-significant multipliers 508, 514, 518 may receive the one or more least-significant inputs 507a, 511a, 517a, 517d when a full precision region is identified. The one or more least significant multipliers 508, 514, 518 may receive the one or more zero inputs (e.g., a value of zero) when a deferred precision region is identified.

The estimated power savings may be computed based on (X_{M}+X_{L})·(Y_{M}+Y_{L})=X_{M}Y_{M}+X_{M}Y_{L}+X_{L}Y_{M}+X_{L}Y_{L}. For example, for 8 bit operands with 3 bit deferred precision, the power savings may be ˜60% power savings (not accounting for additional savings available from reducing multiplier sizing).

The estimated power savings may be based on the allowance for quantization noise. The output of the equalizer (e.g., FFE) may have close-to-Gaussian quantization noise. An 8b×8b multiply operation may involve 64 additions, which may provide greater than 7 orders of magnitude agreement.

The estimated power savings may also be based on scenarios in which the operand in the equalizer (e.g., FFE) may have its own level of deferred precision. Alternatively or in addition, multiplier sizing may be reduced due to reduced computations within a clock interval. Power savings may also occur when deferred precision is combined with partial equalization to further reduce power. Using aggressive rounding may result in power savings; therefore, multiple thresholds may be used.

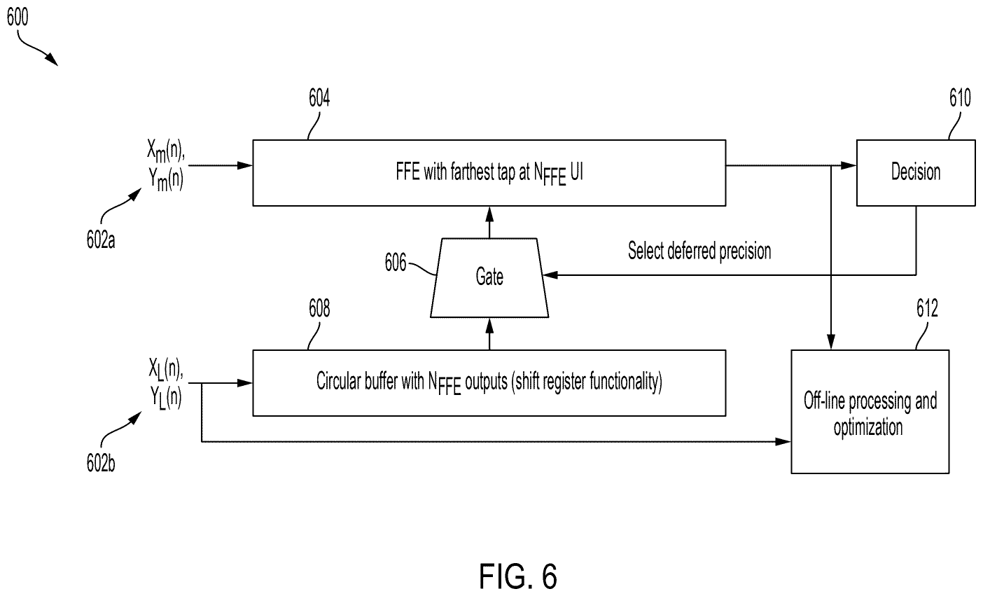

As illustrated in FIG. 6, a system 600 for reduced precision may include an equalizer 604 (e.g., a FFE) including a plurality of taps; a circular buffer 608 to output one or more full precision outputs; and a gate 606 to output the one or more full precision outputs to the equalizer 604 when a full precision region is identified. The system may include one or more processors that may adjust the full precision region. Alternatively, or in addition, the one or more processors may adjust a deferred precision threshold to adjust a deferred precision region. Alternatively or in addition, the one or more processors may compute quantization noise. Alternatively or in addition, the one or more processors may adjust a number of most significant bits based on the quantization noise. The one or more processors may compute, at the receiver, a deferred precision region based on the number of most significant bits.

The pipeline may be initialized with full precision on the taps. The most significant bit operands, X_{M} (n), Y_{M} (n), 602a may be input to an equalizer 604 (e.g., FFE) with a farthest tap at N_{FFE} unit interval (UI). The output of the equalizer 604 may be used to make a decision 610 (e.g., full precision, deferred precision). Least significant bit operands, X_{L}(n), Y_{L}(n), 602b may be input to a circular buffer 608 with N_{FFE} outputs (e.g., using shift register functionality). The least significant operands 602b may be released through a gate 606 which may be gated using the output of the decision 610 (e.g., the gate may be opened when full precision is selected).

The output of the equalizer 604 and the least significant operands 602b may be input to an off-line processing and optimization block 612. The off-line testing and optimization block 612 may use statistics-gathering using snapshot of FFE, (X_{M}, X_{L}) and (Y_{M}, Y_{L}) values. The off-line testing and optimization block 612 may adaptively learn what the best threshold choices may be.

Alternatively or in addition, the deferred precision pipeline may be applied to frequency division duplexing (FDD) equalization. Deferred precision within fast Fourier transform (FFT) may be applied until low-precision equalized output may be obtained. Adding precision to FFT may depend on the region that low-precision output lands in.

Deferred precision may be implemented in decision feedback equalization, ii) maximum likelihood sequence estimation, (iii) belief propagation and/or (iv) low density parity check (LDPC) coding. In these cases, information that falls within a hard decision region may be used to determine information that falls within a deferred decision region. In some cases, the partial information obtained from determining information that falls within a hard decision region may be adequate for the particular use case. As a result, the amount of processing may be reduced relative to a baseline and the performance (e.g., effective number of bits) may be maintained.

In some cases, deferred precision may be applied independently of other techniques (e.g., partial equalization, deferred resolution). In other cases, deferred precision may be applied in conjunction with other techniques (e.g., partial equalization, deferred resolution).

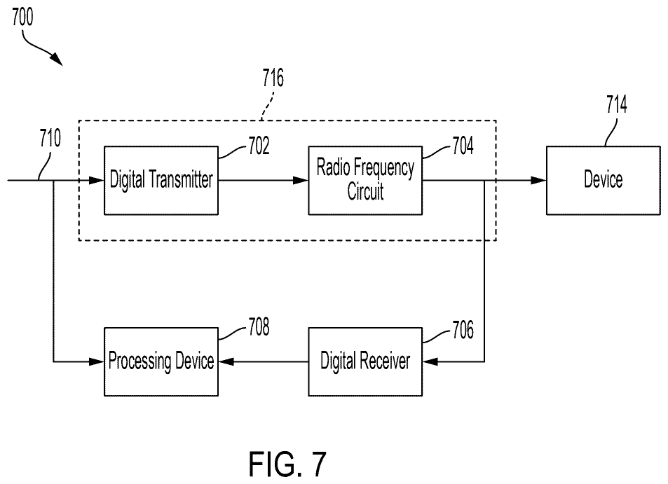

FIG. 7 illustrates a block diagram of an example communication system 700 configured for deferred precision, in accordance with at least one example described in the present disclosure. The communication system 700 may include a digital transmitter 702, a radio frequency circuit 704, a device 714, a digital receiver 706, and a processing device 708. The digital transmitter 702 and the processing device may be configured to receive a baseband signal via connection 710. A transceiver 716 may comprise the digital transmitter 702 and the radio frequency circuit 704.

In some examples, the communication system 700 may include a system of devices that may be configured to communicate with one another via a wired or wireline connection. For example, a wired connection in the communication system 700 may include one or more Ethernet cables, one or more fiber-optic cables, and/or other similar wired communication mediums. Alternatively, or additionally, the communication system 700 may include a system of devices that may be configured to communicate via one or more wireless connections. For example, the communication system 700 may include one or more devices configured to transmit and/or receive radio waves, microwaves, ultrasonic waves, optical waves, electromagnetic induction, and/or similar wireless communications. Alternatively, or additionally, the communication system 700 may include combinations of wireless and/or wired connections. In these and other examples, the communication system 700 may include one or more devices that may be configured to obtain a baseband signal, perform one or more operations to the baseband signal to generate a modified baseband signal, and transmit the modified baseband signal, such as to one or more loads.

In some examples, the communication system 700 may include one or more communication channels that may communicatively couple systems and/or devices included in the communication system 700. For example, the transceiver 716 may be communicatively coupled to the device 714.

In some examples, the transceiver 716 may be configured to obtain a baseband signal. For example, as described herein, the transceiver 716 may be configured to generate a baseband signal and/or receive a baseband signal from another device. In some examples, the transceiver 716 may be configured to transmit the baseband signal. For example, upon obtaining the baseband signal, the transceiver 716 may be configured to transmit the baseband signal to a separate device, such as the device 714. Alternatively, or additionally, the transceiver 716 may be configured to modify, condition, and/or transform the baseband signal in advance of transmitting the baseband signal. For example, the transceiver 716 may include a quadrature up-converter and/or a digital to analog converter (DAC) that may be configured to modify the baseband signal. Alternatively, or additionally, the transceiver 716 may include a direct radio frequency (RF) sampling converter that may be configured to modify the baseband signal.

In some examples, the digital transmitter 702 may be configured to obtain a baseband signal via connection 710. In some examples, the digital transmitter 702 may be configured to up-convert the baseband signal. For example, the digital transmitter 702 may include a quadrature up-converter to apply to the baseband signal. In some examples, the digital transmitter 702 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 702.

In some examples, the transceiver 716 may include one or more subcomponents that may be used in preparing the baseband signal and/or transmitting the baseband signal. For example, the transceiver 716 may include an RF front end (e.g., in a wireless environment) which may include a power amplifier (PA), a digital transmitter (e.g., 702), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 704) of the transceiver 716 may be synchronized with the resource controller via the S-plane device, which may contribute to high-accuracy timing with respect to a reference clock.

In some examples, the transceiver 716 may be configured to obtain the baseband signal for transmission. For example, the transceiver 716 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 716 may be configured to generate a baseband signal for transmission. In these and other examples, the transceiver 716 may be configured to transmit the baseband signal to another device, such as the device 714.

In some examples, the transceiver 716 may be configured to receive a transmission from the transceiver 716. For example, the transceiver 716 may be configured to transmit a baseband signal to the device 714.

In some examples, the radio frequency circuit 704 may be configured to transmit the digital signal received from the digital transmitter 702. In some examples, the radio frequency circuit 704 may be configured to transmit the digital signal to the device 714 and/or the digital receiver 706. In some examples, the digital receiver 706 may be configured to receive a digital signal from the RF circuit and/or send a digital signal to the processing device 708.

In some examples, the processing device 708 may be a standalone device or system, as illustrated. Alternatively, or additionally, the processing device 708 may be a component of another device and/or system. For example, in some examples, the processing device 708 may be included in the transceiver 716. In instances in which the processing device 708 is a standalone device or system, the processing device 708 may be configured to communicate with additional devices and/or systems remote from the processing device 708, such as the transceiver 716 and/or the device 714. For example, the processing device 708 may be configured to send and/or receive transmissions from the transceiver 716 and/or the device 714. In some examples, the processing device 708 may be combined with other elements of the communication system 700.

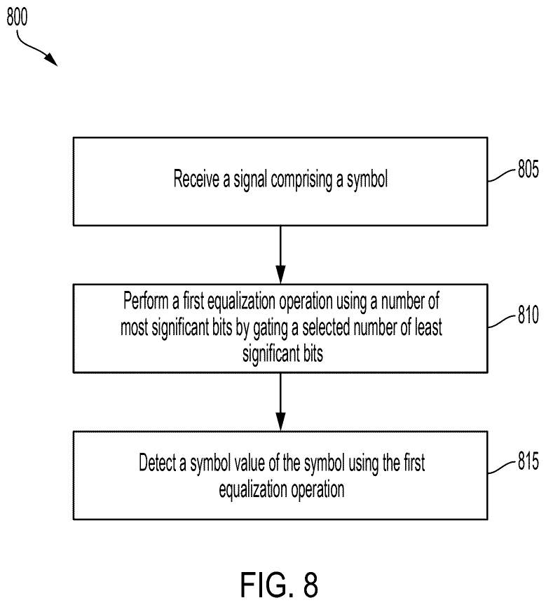

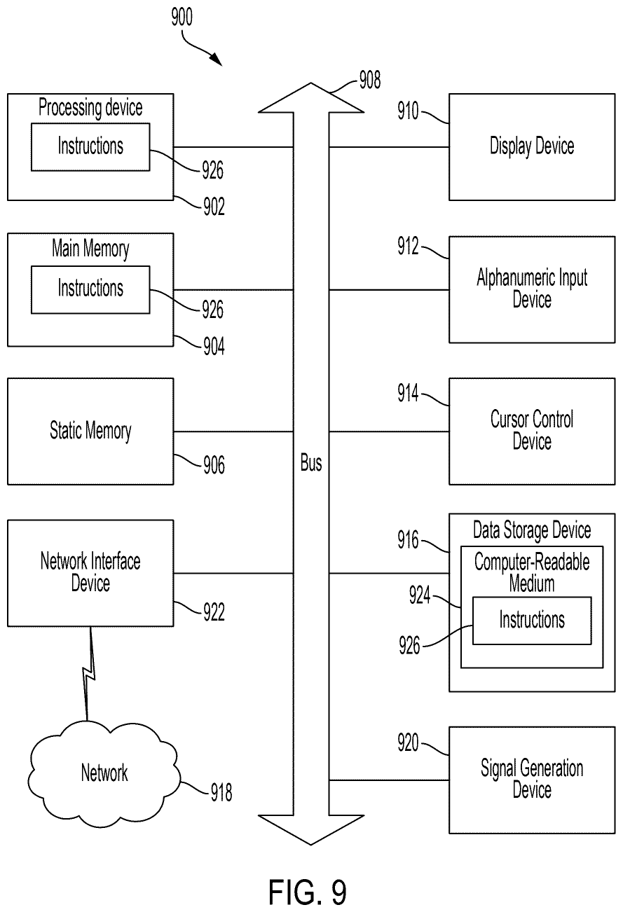

FIG. 8 illustrates a process flow of an example method 800 of deferred precision, in accordance with at least one example described in the present disclosure. The method 800 may be arranged in accordance with at least one example described in the present disclosure. The method 800 may be performed by processing logic that may include hardware (circuitry, dedicated logic, etc.), software (such as is run on a computer system or a dedicated machine), or a combination of both, which processing logic may be included in the processor (e.g., the processing device 902 of FIG. 9), the communication system 700 of FIG. 7, or another device, combination of devices, or systems.

The method 800 may begin at block 805 where the processing logic may receive, at a receiver, a signal comprising a symbol. At block 810, the processing logic may perform, at the receiver, a first equalization operation using a number of most significant bits by gating a selected number of least significant bits. At block 815, the processing logic may detect, at the receiver, a symbol value of the symbol using the first equalization operation.

Modifications, additions, or omissions may be made to the method 800 without departing from the scope of the present disclosure. For example, in some examples, the method 800 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 9 illustrates a diagrammatic representation of a machine in the example form of a computing device 900 within which a set of instructions, for causing the machine to perform any one or more of the methods discussed herein, may be executed. The computing device 900 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 900 includes a processing device 902, a main memory 904 (e.g., read-only memory (ROM), flash memory, dynamic random access memory (DRAM) such as synchronous DRAM (SDRAM)), a static memory 906 (e.g., flash memory, static random access memory (SRAM)) and a data storage device 916, which communicate with each other via a bus 908.

Processing device 902 represents one or more general-purpose processing devices such as a microprocessor, central processing unit, or the like. More particularly, the processing device 902 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 902 may also include one or more special-purpose processing devices such as an application specific integrated circuit (ASIC), a field programmable gate array (FPGA), a digital signal processor (DSP), network processor, or the like. The processing device 902 is configured to execute instructions 926 for performing the operations and steps discussed herein.

The computing device 900 may further include a network interface device 922 which may communicate with a network 918. The computing device 900 also may include a display device 910 (e.g., a liquid crystal display (LCD) or a cathode ray tube (CRT)), an alphanumeric input device 912 (e.g., a keyboard), a cursor control device 914 (e.g., a mouse) and a signal generation device 920 (e.g., a speaker). In at least one example, the display device 910, the alphanumeric input device 912, and the cursor control device 914 may be combined into a single component or device (e.g., an LCD touch screen).

The data storage device 916 may include a computer-readable storage medium 924 on which is stored one or more sets of instructions 926 embodying any one or more of the methods or functions described herein. The instructions 926 may also reside, completely or at least partially, within the main memory 904 and/or within the processing device 902 during execution thereof by the computing device 900, the main memory 904 and the processing device 902 also constituting computer-readable media. The instructions may further be transmitted or received over a network 918 via the network interface device 922.

While the computer-readable storage medium 924 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

### EXAMPLES

The following provide examples of the performance characteristics according to the present disclosure.

### Example 1: Multiple Thresholds

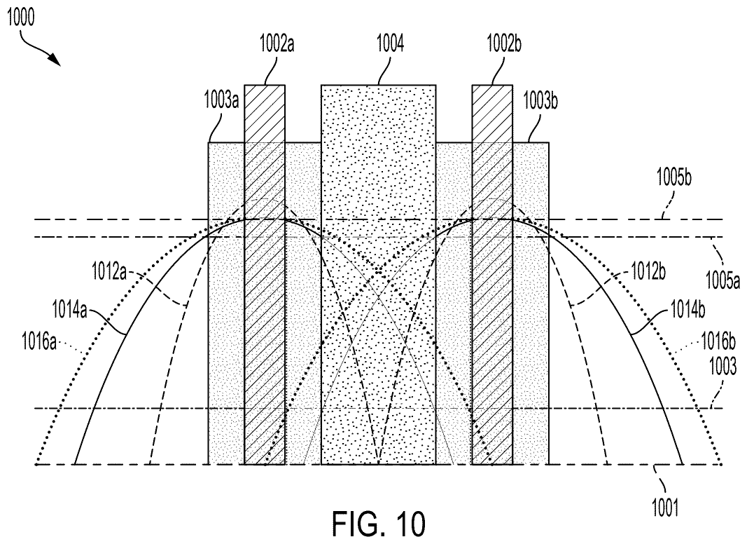

FIG. 10 illustrates an example graph 1000 for deferred precision having multiple thresholds (e.g., conservative rounding 1005a, aggressive rounding 1005b). The example graph includes a full precision region 1004, a conservative rounding region 1003a, 1003b, and an aggressive rounding region 1002a, 1002b. Even though the aggressive rounding region 1002a, 1002b may be perceptually narrow, the probability of landing in the aggressive rounding region 1002a, 1002b may be designed to be significant e.g. 50% probability of rounding half the total bit width which may lead to a 37.5% total power reduction.

The aggressive rounding region 1002a, 1002b may be associated with aggressive rounding histograms 1016a, 1016b. The conservative rounding region may be associated with conservative rounding histograms 1014a, 1014b. Other histograms 1012a, 1012b may also be computed. The multiple thresholds may be based on a target symbol error rate (SER) 1003. The SER floor 1001 may be an achievable SER.

### Example 2: LDPC Coding

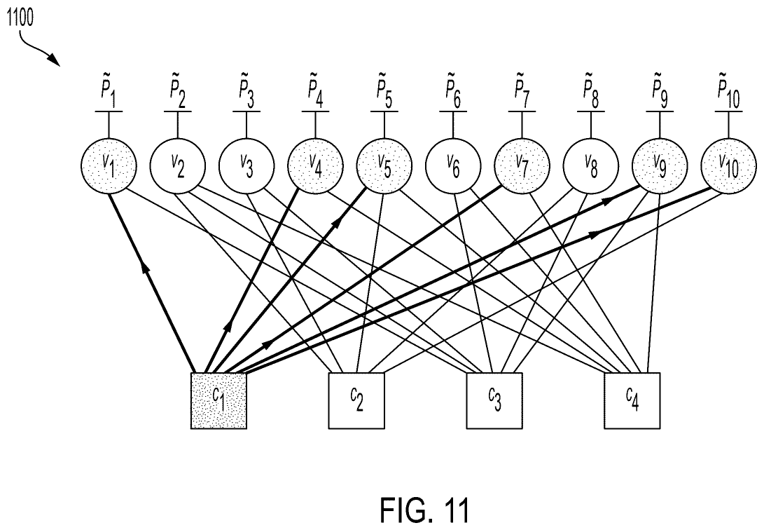

FIG. 11 illustrates an example diagrammatic representation 1100 for applying deferred precision to low density parity check (LDPC) coding. The variable nodes, v1 to v10 may be estimated using confidence estimators, c1 to c4. The confidence estimators may use deferred precision to estimate the variable nodes. For example, when the nodes have a log likelihood ratio below some threshold, then the variable node may have a particular value.

### Example 3: Convoluted Neural Network (CNN)/Large Language Model (LLM)

The softmax function may be

$${σ ( z )}_{i} = \frac{{e}^{{z}_{i}}}{{\sum }_{j = 1}^{K} {e}^{{z}_{j}}} for i = 1 , … , K and z = ( {z}_{1} , … , {z}_{K} ) ∈ {R}^{K}$$

The softmax function may be a multidimensional sigmoid function that may convert a vector of K real numbers into a probability distribution of K possible outcomes. Classification in LLMs may rely on the softmax function residing at the output. Matrix multiplication may be performed at a lower resolution similarly. Deferred precision may be activated for preceding products when SoftMax outputs fall below a certain threshold. When deferred precision is used, classification and training power may be reduced for some cases.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A method, comprising:
receiving, at a receiver, a signal comprising a symbol;
performing, at the receiver, a first operation using a number of most significant bits by gating a selected number of least significant bits; and
detecting, at the receiver, a symbol value of the symbol using the first operation.

2. The method of claim 1, further comprising:
computing, at the receiver, quantization noise in response to the first operation.

3. The method of claim 2, further comprising:
adjusting, at the receiver, the number of most significant bits based on the quantization noise.

4. The method of claim 3, wherein the quantization noise is less than a width of a deferred precision region.

5. The method of claim 1, further comprising:
computing, at the receiver, a deferred precision region based on the selected number of the least significant bits.

6. The method of claim 1, further comprising:
computing, at the receiver, a full precision region based on the selected number of the least significant bits.

7. The method of claim 6, further comprising:
using, at the receiver, the selected number of the least significant bits when the symbol value is in the full precision region.

8. The method of claim 1, further comprising:
performing, at the receiver, the first operation using a feed forward equalizer.

9. The method of claim 1, further comprising:
selecting, at the receiver, a deferred precision threshold.

10. The method of claim 9, further comprising:
computing, at the receiver, a deferred precision region based on the deferred precision threshold.

11. A system for reduced precision, comprising:
a most-significant multiplier operable to receive one or more first most-significant inputs and one or more second most-significant inputs and generate a most-significant output;
a least-significant multiplier operable to receive one or more least-significant inputs or one or more zero inputs and generate a least-significant output; and
an adder operable to receive the most-significant output and the least-significant output and generate a deferred precision output.

12. The system of claim 11, wherein the least significant multiplier is operable to receive the one or more least-significant inputs when a full precision region is identified.

13. The system of claim 11, wherein the least significant multiplier is operable to receive the one or more zero inputs when a deferred precision region is identified.

14. A system for reduced precision, comprising:
an equalizer comprising a plurality of taps;
a circular buffer operable to output one or more full precision outputs; and
a gate operable to output the one or more full precision outputs to the equalizer when a full precision region is identified.

15. The system of claim 14, wherein the equalizer is a feed forward equalizer.

16. The system of claim 14, further comprising one or more processors operable to adjust the full precision region.

17. The system of claim 16, wherein the one or more processors are further operable to adjust a deferred precision threshold to adjust a deferred precision region.

18. The system of claim 16, wherein the one or more processors are further operable to compute quantization noise.

19. The system of claim 18, wherein the one or more processors are further operable to adjust a number of most significant bits based on the quantization noise.

20. The system of claim 19, wherein the one or more processors are further operable to compute a deferred precision region based on the number of most significant bits.
